(19) United States
(12) Patent Application Publication
(10) Pub. No.: US 2005/0277404 A1
(43) Pub. Date: Dec. 15, 2005

(54) Activatable security mechanism

(75) Inventor: Heribert Hartlage, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/149,381

(22) Filed: Jun. 8, 2005

(30) Foreign Application Priority Data
Jun. 8, 2004 (EP) 04013532.9

(51) Int. Cl. H04M 1/66

(52) U.S. Cl. 455/410

(57) ABSTRACT

Applications OLM, ETM, NML, EM of an operations system OS or, as the case may be, network elements NE of a communication network KN are manufactured with a deactivated security mechanism SM which will be activated at a later time—in particular following completion of a customer-specific configuration during manufacture or during commissioning at the premises of the user of the product. This enables secure steps to be omitted at the manufacturer's facility if they are not necessary.

### CROSS REFERENCE TO RELATED APPLICATIONS

This application claims priority to the European application No. 04013532.9, filed Jun. 8, 2004 and which is incorporated by reference herein in its entirety.

### FIELD OF INVENTION

The invention is related to a activatable security mechanism.

### SUMMARY OF THE INVENTION

In the international standard M.3010 (02/2000) of the ITU-T there is a description of a reference architecture of a Telecommunications Management Network (TMN) for monitoring and controlling a network for telecommunications applications in which it is taken as a starting point that the network controlled by the TMN comprises different types of network elements which are customarily controlled with the aid of different communication mechanisms (i.e. protocols, messages, management information—also termed object model).

Said TMN comprises the following functionalities:
Operations Systems Function (OSF), which implements the “actual” management of the telecommunications network.
Workstation Function (WSF), which serves to visualize the control operations and the network status for a human user of the TMN.
Network Element Function (NEF), which represents an interface for controlling the telecommunications functions of the network elements. The interface defines the respective network element's specific communication mechanism, which is possibly not standardized. The sum total of all the management information of the network element (NE) is referred to as the Management Information Base (MIB) of the NE. In the following it will also be referred to as the NE-MIB.
Transformation Function (TF), which is used to link components having different communication mechanisms and in particular for connecting network elements which do not have a standardized NEF to the TMN. In the M.3010 (05/96) standard it is also referred to as the mediation function or as the Q-adaption function.

Furthermore the functionalities are classified into the following groups as far as possible according to the FCAPS scheme:
F=Fault
C=Configuration
A=Accounting
P=Performance
S=Security

The functions are effected by means of material products which may be embodied, for example, as a network element (NE), operations system (OS), application, terminal, router, switch, database server or program, but are not, of course, limited to these.

The NEF function is typically assigned to an NE, whereas the OSF and WSF functions are generally assigned to an OS. Normally a plurality of NEs are assigned to an OS, the OS mostly being centralized, whereas the NEs are distributed non-centrally in the network across a plurality of locations.

A Data Communication Network (DCN) can be provided between NE and OS for the purpose of transmitting information. The transmission follows the principles of the transport service, as described in the lower layers of the ISO/OSI reference model in the X.200 international standard.

An OS can comprise a plurality of programs—also referred to as applications or software. The programs can be embodied for example as management applications for controlling different network technologies of a communication network, by which in each case one application-specific subset of the resources of the network relevant to the technology being controlled in each case is modeled, visualized and controlled.

The programs are executed by hardware (e.g. processor, I/O module) which is provided in the devices. Said execution is supported by support software (e.g. multitasking or, as the case may be, multithreading operating system, database system, Windows system).

The security functionality is implemented in the products for example by means of security mechanisms in which secure access to the products is generally made possible by way of a user identification (userid) and a password and/or through presentation of a security certificate.

In contemporary systems all the security mechanisms present in the OS and NE are effective immediately in the basic state. At the time of the first access to the products—e.g. in the factory or during commissioning at the customer site—a “default userid” and a “default password” are already provided, no access being possible unless they are input. Following the first access, further userIDs together with associated passwords can be set up by appropriately privileged users of the products.

After what has been explained so far it is clear that the implementation of the described architecture in real solutions constitutes an extremely complex technical problem in view of the marked distributed nature of the system and the multiplicity of different system components and requirements.

The object of the invention is to recognize at least one of the existing problems and provide a solution by the specification of at least one directive for technical actions.

The invention is based on the following findings:
Inputting a userId and password is time-consuming. The time required for this is all the greater, the more products there are that are provided with a security mechanism. They become a relevant time entity if, in addition, a plurality of secure accesses are effected in a comparatively short period of time.
The access data, “default userId” and “default password”, is usually managed separately for each product. The “default userid” and “default password” can therefore be different from product to product. This leads to unwelcome delays during commissioning for example if userId and/or password are not known as a result of the differences and have to be laboriously ascertained.

Particularly sophisticated security mechanisms, such as the use of certificates, then also necessitate an additional logistical and administrative overhead which is at odds with efficient production, a tailor-made customer-specific configuration and problem-free commissioning at the customer site.

Controlling access by means of a security mechanism is not always necessary. Thus, for instance, a security mechanism can be dispensed with for a given product if the product is not (yet) being used in a security-relevant environment. In particular secure access to an OS or to an NE (i.e. with use of a security mechanism) is not necessary in the factory for the installation of customer-specific settings and/or during the commissioning at the customer site.

A solution for this problem situation recognized according to the invention as well as advantageous embodiments of said solution are set forth in the claims.

A great many advantages are associated with said solution and are described in the exemplary embodiments of the invention.
If the security mechanism is initially deactivated, customer-specific configurations can be loaded more easily and more efficiently in the factory without the need to take account of security mechanisms.
Commissioning at the customer site can be carried out more easily and more efficiently, precisely because there is no need to specify a userId and password in order to access the system, which access may be necessary a number of times.
The operator can also operate the OS or the NE without security mechanisms when necessary.
Where alternative security mechanisms are offered, such as access control based on userId and password or access control by means of security certificates based on a smartcard, then optionally either only one of the two security mechanisms or both can be activated irreversibly according to the operator's requirements.
For manufacturers there is the attractive advantage that where there are a plurality of different security mechanisms each security mechanism can be marketed separately.
All the software including the parts that require or alternatively also do not require access by means of userId and password is already present on the OS or the NE and does not need to be installed retroactively. The initially inoperative security mechanism, such as the specification of userId and password, is already integrated, though not yet activated. This means that in the case of a product embodied as a program the security mechanism can be activated without the need for a recompilation of the program by being selectively enabled for example by means of corresponding license keys.
After the commissioning of the product at the customer site has been completed, the security mechanism can be activated by means of a special command. Once activated, the security mechanism cannot be deactivated again. When the security mechanism has been activated, the userId and the password for example must always be submitted to the OS or the NE in order that the system may grant access to a user. This ensures that a security mechanism, once activated, cannot be deactivated again.
By virtue of the fact that the activation leads to selected storage locations being modified in such a way that initially information is stored about the use of the security mechanisms and subsequently only read access is allowed to these storage locations, it is ensured that it is not possible to circumvent the activated security mechanism, not even when the software of the OS or the software on the NE is restarted (“booted”). This also applies when parts of the software or all of the software are/is reinstalled on the system and then a restart is performed. The same advantage is obtained if in addition or alternatively parts of the software which previously allowed access without requiring the specification of userId and password are replaced by such software components that now necessitate said specification. This is effected for example by means of hidden files or replaced software components (e.g. a DLL). Moreover, with the activation of the security mechanism the software components that specifically do not require a userId and password can be deleted.
For a network operator, economic advantages are produced as a result of a reduction in the OPEX (OPerational EXpenses).
An implementation of the invention requires no fundamental changes to the existing prior art, but can be inserted retroactively as a component—in particular as a modified or additional computer program product. The time of the implementation can be chosen independently of other functions.

The invention will be explained below with reference to further exemplary embodiments which are also shown in the figures. It should be emphasized that in spite of their, in some cases very detailed, description the illustrated embodiments of the invention are to be understood as being merely of an exemplary nature and not limiting.

### BRIEF DESCRIPTION OF THE DRAWING

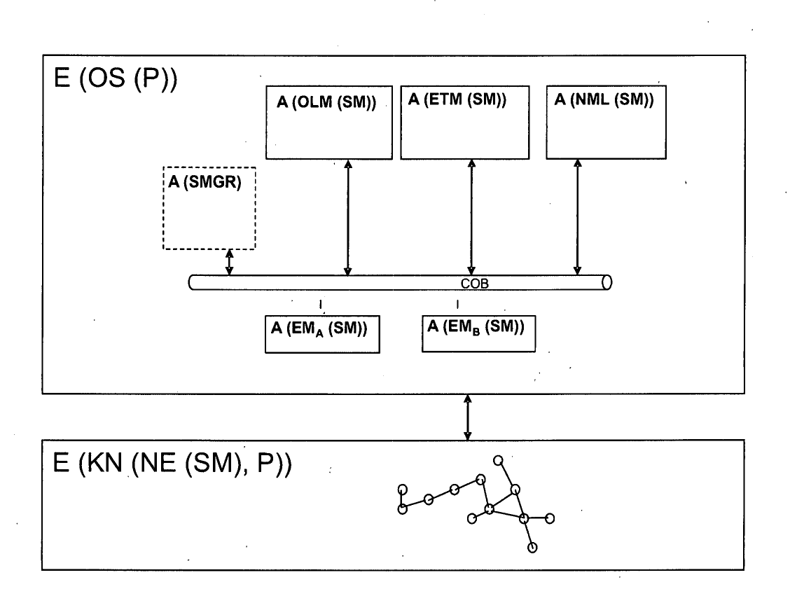

The sole FIGURE 1 shows an exemplary arrangement, comprising a central operations system OS having applications A for controlling decentralized elements NE of a communication network KN and an optional application security manager SMGR.

### DETAILED DESCRIPTION OF THE INVENTION

The exemplary embodiments will be explained with reference to the arrangement shown in FIG. 1, which comprises a plurality of material products E disposed in a distributed arrangement. The products E are embodied for example as decentralized, distributed network elements NE of a communication network KN or as a central operations system OS having applications A for controlling the decentralized elements NE of the communication network KN. The applications A are embodied for example as management applications Optical Link Manager OML, Network Management Layer NML, Ethernet Manager ETM or Element Manager EMA, EMB as well as an optional Security Manager SMGR. The products embodied as applications A can be assigned the TMN function blocks Operations Systems Function (OSF) and Workstation Function (WSF), while the products embodied as network elements NE can be assigned the TMN function block Network Element Function (NEF). The applications A are interconnected by means of a data network COB. The operations system OS and the network elements NE are connected by means of a data network, referred to among the technical community as a Data Communication Network (DCN). The products comprise hardware—in particular processors and storage resources—with the aid of which in particular those products E are performed which are embodied as a computer program product P or, as the case may be, as a program P. The hardware can also correspond directly to the products E, for example as an Application Specific Integrated Circuit (ASIC) or an equivalent material product E.

The products E embodied as a management application OML, NML, ETM, EM or, as the case may be, as a network element NE are each assigned a security mechanism SM because said products E must not be controlled without restriction by arbitrary individuals. However, according to the knowledge of the invention said restriction relates primarily to the productive operation of said products, but not to the same extent to their manufacture, pre-configuration and commissioning. According to the knowledge of the invention a security mechanism SM can be dispensed with during these phases.

According to the invention said products E are therefore produced with a deactivated security mechanism SM which will not be activated until a later time. The security mechanism SM is preferably activated following completion of a customer-specific configuration during manufacture or commissioning at the premises of the user of the product.

The security mechanism SM is preferably integrated into the products E during their manufacture in such a way that at the time of activation no subsequent integration—in particular retroactive installation—of the security mechanism SM is required. Associated therewith is the attractive advantage that the activation can be effected solely with the aid of at least one license key and/or one activation command. The integration can also comprise a pointer to a security manager SMGR. In this case the security manager SMGR should be configured in such a way that it initially has a deactivated security mechanism for the product E just manufactured. This can be effected for example such that in the security manager SMGR all non-activated security mechanisms SM are always deactivated by default.

The optional activation is effected according to the respective embodiment of the product E. For example, there can be provided in an ASIC a special storage location whose respective value indicates the activation state. Otherwise a special file can be provided which is representative of an activated security mechanism SM if it is present and vice versa. Alternatively, in the case of a product embodied as a program P, a special dynamic link library (DLL) can be replaced, with a first DLL containing a deactivated security mechanism SM and a second DLL an activated security mechanism SM.

Finally the security mechanism SM can be exported to a special application security manager SMGR. The assigned products E then contain a pointer to the security manager, through which a pass is executed, preferably mandatorily, when the products E are started up. The pointer leads for example to a query to the security manager SMGR to ascertain whether the security mechanism is activated or deactivated at the present time. A security check is then performed or not performed depending on the response.

According to a variant of the invention the activation is effected in such a way that a subsequent deactivation of a once activated security mechanism SM is ruled out. Toward that end, for example, the special storage location in the ASIC can be embodied so that during the manufacture it is initially representative of a deactivated security mechanism SM and subsequently can be changed precisely once and is then representative of a permanently activated security mechanism SM, because henceforth it can only be accessed for reading but can no longer be changed. Alternatively the special file can be created as a hidden file which is not visible to or cannot be found by an ordinary user of the system because it is stored at an unexpected location. Furthermore, in the case of a product embodied as a program P, following the replacement of the DLLs the first DLL, which contains the deactivated security mechanism SM, can be deleted. Finally the security manager SMGR could be implemented in such a way that no provision is made for a deactivation of a once activated security mechanism SM.

The security mechanism SM can be provided in a plurality of forms. It is embodied for example as a userId with password or as a security certificate based on a smartcard. According to the invention, in this case each embodiment can optionally be activated individually. The prohibition of the subsequent deactivation can also optionally be set on an individual basis, i.e. per security mechanism SM.

By means of the invention it is ensured that the individual components of the overall system are only subjected to load to a limited extent, thereby increasing the stability of the system as a whole.

In conclusion it should be pointed out that the description of the components of the system that are relevant to the invention should categorically not be understood as limiting with regard to a specific physical implementation or assignment. For a relevant person reasonably skilled in the art it is self-evident in particular that all the products can be implemented in part or in their entirety in software/computer program products and/or in a distributed arrangement by way of a plurality of physical devices.

1-11. (canceled)

12. A method for controlling access to a product having at least one activatable security mechanism assigned to the product, the method comprising:
manufacturing the product with a deactivated security mechanism; and
activating the security mechanism at a later time.

13. The method in accordance with claim 12, wherein the product is an application embodied as a program of an operations system or a network element of a communication network.

14. The method in accordance with claim 12, wherein the security mechanism is activated following completion of a customer-specific configuration during manufacture or commissioning at the premises of a user of the product.

15. The method in accordance with claim 13, wherein the security mechanism is activated following completion of a customer-specific configuration during manufacture or commissioning at the premises of a user of the product.

16. The method in accordance with claim 12, wherein in the event that a plurality of security mechanisms are provided these can optionally be activated individually.

17. The method in accordance with claim 14, wherein in the event that a plurality of security mechanisms are provided these can optionally be activated individually.

18. The method in accordance with claim 12, wherein the security mechanism is integrated into the product during manufacture such that at the time of activation no subsequent integration of the security mechanism is required.

19. The method in accordance with claim 13, wherein the security mechanism is integrated into the product during manufacture such that at the time of activation no subsequent integration of the security mechanism is required.

20. The method in accordance with claim 12, wherein the security mechanism is integrated into the product during manufacture in such a way that at the time of activation no retroactive installation of the security mechanism is required.

21. The method in accordance with claim 12, wherein the security mechanism is activated with the aid of at least one license key and/or one activation command.

22. The method in accordance with claim 12, wherein the product is manufactured with an active connection and/or a mechanical linkage to a security manager which is assigned to the product and comprises the security mechanism.

23. The method in accordance with claim 12, wherein a deactivation of a once activated security mechanism is ruled out.

24. The method in accordance with claim 23, wherein the exclusion of the deactivation is supported by at least one of the following measures:
modification of storage locations in such a way that following the activation they can henceforth only be accessed for reading,
creation of at least one hidden file and/or one file entry,
replacement of a component of the product,
replacement of a dynamic link library of the product,
deletion of the deactivated security mechanism, or
deletion of the software without security mechanism.

25. A product, comprising mechanisms for performing the method according claim 12.

26. The product in accordance with claim 25, wherein the product is an application of an operations system or a network element of a communication network.

27. The product in accordance with claim 25, wherein the product is embodied as a computer program product whose program code is executable by at least one processor for the purpose of performing the method according claim 12.

28. A product, comprising:
first means for performing those steps of the method according to claim 12 which are effected by the product; and
second means for performing interactions, prescribed according to the method as claimed in claim 12, of the product with further products by which the remaining steps of the method are performed.

29. The product in accordance with claim 28, wherein the product is a security manager.

30. The product in accordance with claim 28, wherein the product is embodied as a computer program product whose program code is executable by at least one processor for the purpose of performing the method according claim 12.

31. The product in accordance with claim 28, wherein the further products are management applications of an operations system or network elements of a communication network.
